(19) United States
(12) Patent Application Publication
(10) Pub. No.: US 2009/0109211 A1
(43) Pub. Date: Apr. 30, 2009

(54) Liquid crystal display, LCD driver, and operating method of LCD driver

(75) Inventors: Takashi Nose, Kanagawa (JP); Hirobumi Furihata, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC Electronics Corporation, Kawasaki (JP)

(21) Appl. No.: 12/289,454

(22) Filed: Oct. 28, 2008

(30) Foreign Application Priority Data
Oct. 31, 2007 (JP) 2007-283270

(51) Int. Cl. G09G 5/00; G09G 3/28

(52) U.S. Cl. 345/214; 345/64

(57) ABSTRACT

In an aspect of the present invention, a liquid crystal display apparatus includes: a liquid crystal display (LCD) panel; and an LCD driver. The LCD driver includes: a first memory having a capacity more than a capacity of image data for one frame and configured to receive the image data externally to store therein; a second memory; an overdrive processing circuit configured to compress the image data read out from the first memory to generate a compressed image data, write the generated compressed image data in the second memory, and perform an overdrive process based on the image data of a current frame read out from the first memory and the compressed image data of a previous read out from the second memory to generate a post-process image data; and a data line driving section configured to drive data lines of the LCD panel in response to the post-process image data.

### INCORPORATION BY REFERENCE

This patent application claims priority on convention based on Japanese Patent Application No. 2007-283270. The disclosure thereof is incorporated herein by reference.

### BACKGROUND OF THE INVENTION

1. Field of the Invention

The present invention relates to a liquid crystal display, an LCD driver, and an operation method of the LCD driver, and more specifically to, a drive technique of a liquid crystal display panel using overdriving.

2. Description of the Related Art

Since a video function, a television function, and so on are provided in a mobile terminal in recent years, a liquid crystal display of a mobile terminal is required to display a video image.

In the liquid crystal display, a slow response speed of liquid crystal material prevents the video image from being displayed. At present, one frame period is about 16.7 ms (i.e., a frame frequency is about 60 Hz). The response speed of the liquid crystal material is 20 to 30 ms in case of binary display of “white display” and “black display.” In case of gradation display, there is a case that the response speed of the liquid crystal material exceeds 100 ms. For this reason, when an image has changed, several frame periods are required to complete a response of the liquid crystal material, as shown in FIG. 1. This is a cause of blurring of the image.

In order to improve the response speed of the liquid crystal material, overdriving is proposed. In a technique for the overdriving, the response speed of a liquid crystal material is improved by supplying a voltage higher than a usual drive voltage corresponding to a gradation level of a display dot at the time of rising a drive voltage, and supplying a voltage lower than the usual drive voltage corresponding to the gradation level of the display dot at the time of decreasing the drive voltage, when the image is changed, as shown in FIG. 2.

In one technique for the overdriving, a data line is driven based on a display image data of a display dot in a current frame obtained by adding an overdrive value determined based on a difference between an image data in the current frame and an image data in a previous frame to the image data of the current frame. A process of obtaining the display image data by adding the overdrive value and the image data in the current frame is referred to as an overdrive process. Japanese Patent Application Publications (JP-A-Heisei 4-365094, JP-P2002-082657A, and JP-P2006-195231A) as a set of related arts disclose liquid crystal displays in which the overdrive process is performed.

The liquid crystal display in which the overdrive process is performed is provided with a memory for storing the image data in the previous frame. Since it is preferred in the view of reduction of hardware resources that the capacity of this memory is less, there is a case that the image data in the previous frame is compressed and stored in the memory. It should be noted in this specification that the compression of the image data means execution of a process of reducing an amount of the image data, and a term of “compression of image data” is used in a meaning that includes extraction of upper bits of the image data. Japanese Patent Application Publications (JP-A-Heisei 9-81083, JP-P2005-316146A, and JP-P2006-195151A) as another set of related arts disclose liquid crystal displays in which the image data in the previous frame is compressed and stored in the memory.

In the liquid crystal displays disclosed in the sets of related arts, a display image data is calculated by executing the overdrive process on image data in the current frame received externally based on the image data in the previous frame stored in the memory. In the liquid crystal display disclosed by Japanese Patent Application Publication (JP-P2006-195151A), the overdrive process is executed after executing a compressing process and an expansion process of the image data in the current frame received externally. However, the compressing process and the expansion process are executed to match formats between the image data of the current frame and the previous frame alike, and are essentially the same as the other liquid crystal displays.

By the way, there is a problem in applying the configurations disclosed by the above-mentioned sets of related arts to the liquid crystal display of a mobile terminal such as a cellular phone. This is because the liquid crystal displays disclosed in the above-mentioned sets of related arts are fabricated on the presumption that a transfer rate of image data to an LCD (liquid crystal display) driver is constant, although the transfer speed of the image data to the LCD (liquid crystal display) driver is not constant in the liquid crystal display of the mobile terminal in many cases.

In the liquid crystal display for a mobile terminal, an LCD driver often has a display memory to store image data for one frame. The LCD driver having the display memory halts the transfer of the image data from a CPU to the LCD driver in case of a still image, or when only a part of the image data is changed, transfers the changed part. Thus, consumed power is reduced. An interface that is generally called a CPU interface is used for the transfer of the image data between the LCD driver having the display memory and the CPU.

In such a type of LCD driver, a transfer rate of the image data from the CPU, namely a write rate of the image data into the display memory is not constant. There is a case that the image data for one frame is transferred over a period for a plurality of frames, as shown in FIG. 3A, and there is also a case that the image data for one frame is transferred in a period shorter than a period for one frame, as shown in FIG. 3B. In such an LCD driver having the display memory, a clock circuit is provided in the LCD driver to generate a read clock signal used to read the image data from the display memory, separately from a clock circuit which generates a write clock signal shown in FIG. 3A used to write the image data into the display memory. The write clock signal and the read clock signal are asynchronous with each other, and a display unit can be operated at a frame rate of 60 Hz in response to the read clock signal.

Moreover, when only a part of the image data is changed, only the changed part of the image data is transferred. Therefore, the write clock signal is stopped during a period when the image data is not transferred. In this case, for example, there is a case that the image data for one frame is transferred over a period for a plurality of frames, as shown in FIG. 3A, and there is also a case that the image data for one frame is transferred in a period shorter than a period for one frame, as shown in FIG. 3B. The configurations of the liquid crystal displays disclosed in the above-mentioned sets of related arts cannot be applied to a case that the transfer rate of the image data to the LCD driver is not constant.

Therefore, a liquid crystal display with an LCD driver is desired that can execute an overdrive process even in case that the transfer rate of the image data to the LCD driver is not constant while a storage capacity of memory in the LCD driver can be suppressed to a minimum.

### SUMMARY

In an aspect of the present invention, a liquid crystal display apparatus includes: a liquid crystal display (LCD) panel; and an LCD driver. The LCD driver includes: a first memory having a capacity more than a capacity of image data for one frame and configured to receive the image data externally to store therein; a second memory; an overdrive processing circuit configured to compress the image data read out from the first memory to generate a compressed image data, write the generated compressed image data in the second memory, and perform an overdrive process based on the image data of a current frame read out from the first memory and the compressed image data of a previous read out from the second memory to generate a post-process image data; and a data line driving section configured to drive data lines of the LCD panel in response to the post-process image data.

In another aspect of the present invention, a liquid crystal display (LCD) driver includes: a first memory configured to receive the image data externally to store therein; a second memory; an overdrive processing circuit configured to compress the image data read out from the first memory to generate a compressed image data, write the generated compressed image data in the second memory, and perform an overdrive process based on the image data of a current frame read out from the first memory and the compressed image data of a previous read out from the second memory to generate a post-process image data; and a data line driving section configured to drive data lines of a liquid crystal display panel in response to the post-process image data.

In still another aspect of the present invention, an operation method of an LCD driver, includes: receiving an image data externally to store in a first memory of the LCD driver; compressing the image data read from the first memory to generate a compressed image data; writing the generated compressed image data in a second memory of the LCD driver; performing an overdrive process based on the image data of a current frame read from the first memory and the compressed image data of a previous frame read from the second memory, to generate a post-process image data; and driving data lines of a liquid crystal display panel in response to the post-process image data.

According to the present invention, the liquid crystal display that can correspond to the overdrive process even in a case that a transfer speed of image data to a LCD driver is not constant and yet is configured to be able to control an increase of the capacity of memory built into the LCD driver to a minimum is desired.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a graph showing a relation between brightness and a drive voltage in the case that no overdriving is performed;

FIG. 2 is a graph showing a relation between brightness and the drive voltage at the time of performing the overdriving;

FIG. 3A is a timing chart showing operation timing when image data of one frame is transferred to a LCD driver over a plurality of frame periods;

FIG. 3B is a timing chart showing the operation timing when the image data of one frame is transferred to the LCD driver over the plurality of frame periods;

FIG. 4 is a block diagram showing a configuration of a liquid crystal display of a first embodiment of the present invention;

FIG. 5 is a block diagram showing a configuration of an overdrive process circuit in the first embodiment;

FIG. 6 is a diagram showing a format of compressed image data to be written in overdrive memory;

FIG. 7A is a diagram showing contents of a lookup table for R display dots and B display dots that is stored in a LUT circuit for overdrive of the first embodiment;

FIG. 7B is a diagram showing contents of a lookup table for G display dots that is stored in the LUT circuit for overdrive of the first embodiment;

FIG. 8 is a block diagram showing a configuration of an overdrive process circuit in a second embodiment; and

FIG. 9 is a diagram showing contents of a lookup table stored in the LUT circuit for overdrive of the second embodiment.

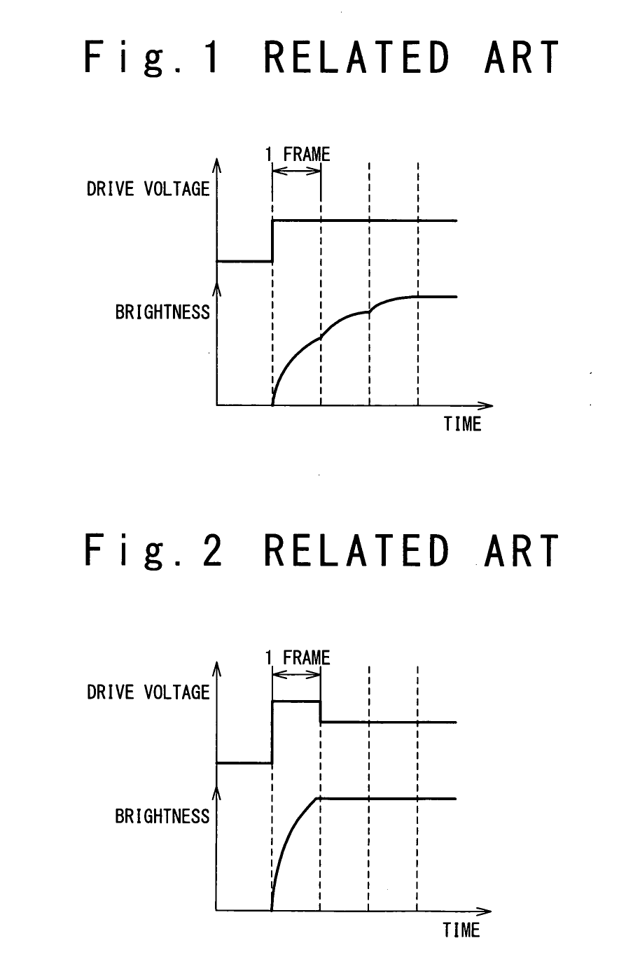

### DESCRIPTION OF THE PREFERRED EMBODIMENTS

Hereinafter, a LCD (liquid crystal display) display apparatus with an LCD driver according to the present invention will be described in detail with reference to the attached drawings.

### First Embodiment

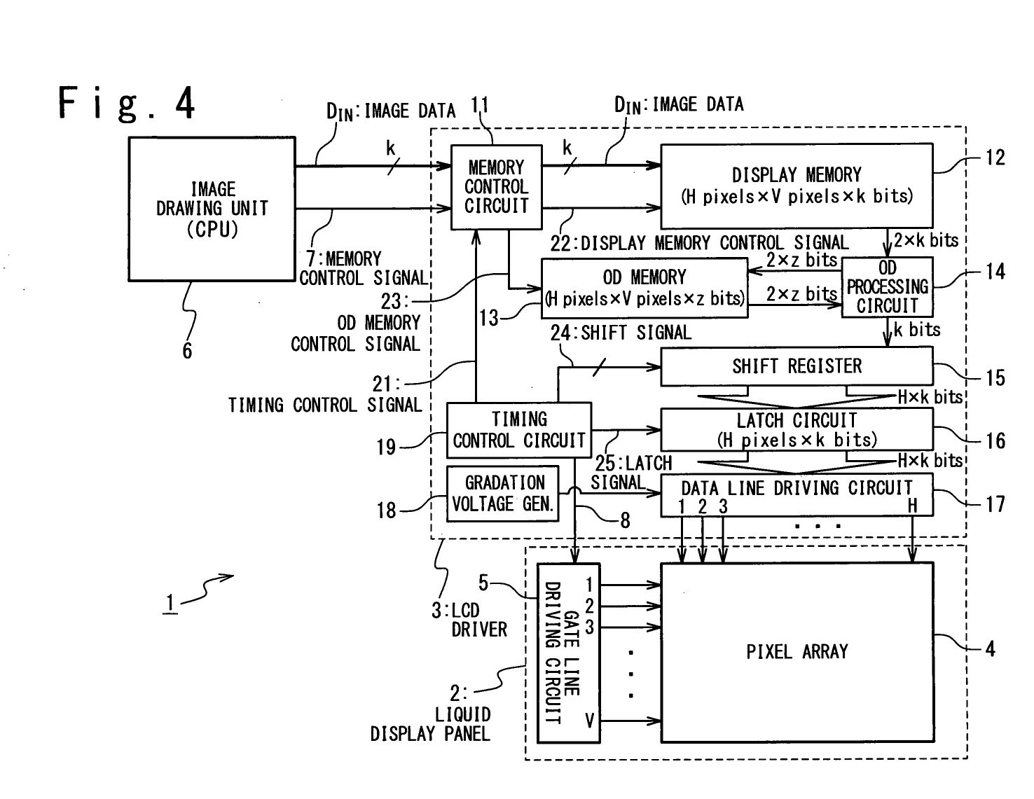

FIG. 4 is a block diagram showing a configuration of an LCD display apparatus 1 according to a first embodiment of the present invention. The LCD display apparatus 1 is provided with a liquid crystal display (LCD) panel 2 and an LCD driver 3.

In the LCD panel 2, a pixel array 4 in which pixels are arranged in a matrix of H rows and V columns and a gate line driving circuit 5 are integrated. In the following description, one row of pixels extending in a horizontal direction of the pixel array 4 may be called one horizontal line of pixels. In the present embodiment, one pixel includes three display dots of red (R), green (G), and blue (B) arranged in the horizontal direction, and therefore display dots for H rows by 3V columns are provided in the pixel array 4. Below, the display dots for displaying red, green, and blue may be called an R display dot, a G display dot, and a B display dot, respectively. Each of the display dots is provided with a thin-film transistor (TFT) and a pixel electrode, and the display dot displays one of red, green, or blue colors at a desired brightness. In order to drive display dots of H rows by 3V columns, the pixel array 4 is provided with H gate lines (scanning lines) extending in the horizontal direction and 3V data lines (signal lines) extending in a vertical direction. The display dots are provided at positions at which the gate lines and the data lines intersect. The gate line driving circuit 5 drives the gate line of the pixel array 4 in response to a gate line drive control signal 8 received from the LCD driver 3.

The LCD driver 3 receives image data D_{IN} externally, specifically, from an image drawing unit 6, and drives the data lines of the LCD panel 2 in response to the image data D_{IN}. The image drawing unit 6 is exemplified by a CPU and a DSP (Digital Signal Processing circuit). The image data D_{IN} is data that expresses gradations of each pixel by k bits (k is a multiple of 3). In detail, k/3 bits of the image data D_{IN} for each pixel indicate a gradation of the R display dot, another k/3 bits indicate a gradation of the G display dot, and the remaining k/3 bits indicate a gradation of the B display dot. In the following description, data bits expressing the gradation of the R display dot of the image data D_{IN} for one pixel are described as R data D_{IN}R, data bits expressing the gradation of the G display dot of the image data D_{IN} are described as G data D_{IN}G, and data bits expressing the gradation of the B display dot of the image data D_{IN} are described as B data D_{IN}B. In addition, the LCD driver 3 also has a function of supplying the gate line drive control signal 8 to the gate line driving circuit 5 of the LCD display panel 2. The LCD driver 3 is supplied with a memory control signal 7 and other control signals from the image drawing unit 6, and the LCD driver 3 operates in response to the supplied control signals. In the present embodiment, communication between the LCD driver 3 and the image drawing unit 6 is performed by means of a CPU interface.

Next, a configuration of the LCD driver 3 will be described. The LCD driver 3 has a memory controller 11, a display memory 12, an overdrive memory 13, an overdrive processing circuit 14, a shift register 15, a latch circuit 16, a data line driving circuit 17, a gradation voltage generating circuit 18, and a timing control circuit 19. These circuits are integrated monolithically in a single semiconductor chip.

The memory control circuit 11 has a function of writing the image data D_{IN} sent from the image drawing unit 6 into the display memory 12. More specifically, the memory control circuit 11 generates a display memory control signal 22 from the memory control signal 7 sent from the image drawing unit 6 and a timing control signal 21 sent from the timing control circuit 19, to control the display memory 12. Further, the memory control circuit 11 transfers the image data D_{IN} sent from the image drawing unit 6 in synchronization with the display memory control signal 22 to the display memory 12, and writes the image data D_{IN} in the display memory 12. In addition, the memory control circuit 11 generates an overdrive memory control signal 23 from the memory control signal 7 and the timing control signal 21, to control the overdrive memory 13.

The memory control signal 7 sent from the image drawing unit 6 includes a write clock signal indicating transfer timing of the image data D_{IN}, and the memory control circuit 11 controls a write operation of the display memory 12 in synchronization with the write clock signal. Moreover, the timing control signal 21 sent from the timing control circuit 19 includes a read clock signal, and the memory control circuit 11 controls a read operation of the display memory 12 in synchronization with the read clock signal. The write operation into the display memory 12 is asynchronous with the read operation.

The display memory 12 temporarily holds the image data D_{IN} sent from the image drawing unit 6. The display memory 12 has a capacity of one frame, i.e., a capacity of H×V×k bits. As will be described later, the pixel data D_{IN} currently held in the display memory 12 is used for an overdrive process and a driving process of the LCD panel 2 as a current frame data (namely, pixel data of the current frame). The display memory 12 outputs the image data D_{IN} to the overdrive processing circuit 14 sequentially in response to the display memory control signal 22 from the memory control circuit 11. As the display memory 12, dual port memory capable of performing the write operation and the read operation independently is used. Outputting the pixel data D_{IN} to the overdrive processing circuit 14 is performed every two pixels of the LCD panel 2 (namely, with a bit width of 2×k bits).

The overdrive (OD) memory 13 is used to store previous frame data (namely, image data of the previous frame) that is used for an overdrive process. However, the pixel data stored in the overdrive memory 13 is a compressed image data generated by compressing the pixel data D_{IN} currently held in the display memory 12 by the overdrive processing circuit 14. In the present embodiment, the compressed image data is data for expressing the gradations of two pixels that is generated from the image data D_{IN} of the two pixels arranged in the horizontal direction with 2×z bits (z<k). Generation of the compressed image data will be described in detail later. The overdrive memory 13 has a capacity for one frame of compressed pixel data, namely, a capacity of H×V×z bits. In order to reduce the size of memory necessary for the overdrive process, it is effective that the compressed pixel data is stored in the overdrive memory 13.

The overdrive processing circuit 14 has two functions. A first function is to generate the compressed pixel data by compressing the pixel data D_{IN} stored in the display memory 12 and to store the compressed pixel data in the overdrive memory as the image data of the previous frame. Another function is to perform the overdrive process of the pixel data D_{IN} currently stored in the display memory 12, using the compressed pixel data currently stored in the overdrive memory 13. The pixel data on which the overdrive process was performed (hereinafter, to be called “post-process pixel data”) is supplied to the shift register 15 sequentially. The post-process pixel data is k-bit data.

The shift register 15 receives and holds the post-process pixel data sent sequentially from the overdrive processing circuit 14. The shift register 15 has a capacity for holding the post-process pixel data for one horizontal line of the LCD panel 2, namely, a capacity of H×k bits, so that it has a role of converting the k-bit data sent from the overdrive processing circuit 14 into H×k-bit data. The operation of the shift register 15 is controlled in response to a shift signal 24 sent from the timing control circuit 19.

The latch circuit 16 simultaneously latches the post-process pixel data for one horizontal line from the shift register 15 in response to a latch signal 25 sent from the timing control circuit 19, and transfers the latched post-process pixel data to the data line driving circuit 17.

The data line driving circuit 17 drives a corresponding data line of the LCD panel 2 in response to the post-process pixel data for one horizontal line sent from the latch circuit 16. More specifically, the data line driving circuit 17 selects a corresponding one among a plurality of gradation voltages supplied from a gradation voltage generating circuit 18 in response to the post-process pixel data, and drives a signal line of the LCD panel 2 corresponding to the selected gradation voltage. In the present embodiment, the number of gradation voltages supplied from the gradation voltage generating circuit 18 is 2k/3.

The timing control circuit 19 has a role of controlling the overall operation of the LCD driver 3. More specifically, the timing control circuit 19 generates the gate line drive control signal 8, the timing control signal 21, the shift signal 24, and the latch signal 25, and supplies them to the gate line driving circuit 5, the memory control circuit 11, and the latch circuit 16, respectively. The timing control of the LCD driver 3 is performed by the gate line drive control signal 8, the timing control signal 21, the shift signal 24, and the latch signal 25. As described above, the read clock signal is included in the timing control signal 21 supplied to the memory control circuit 11.

One of the most important features of the LCD display apparatus of the present embodiment lies in a point that the display memory 12, the overdrive memory 13, and the overdrive processing circuit 14 are monolithically integrated in the LCD driver 3. Such a configuration makes it possible to suppress the increase of the volume of the memory built in the LCD driver 3 to a minimum, while allowing a transfer rate of the image data to be made variable.

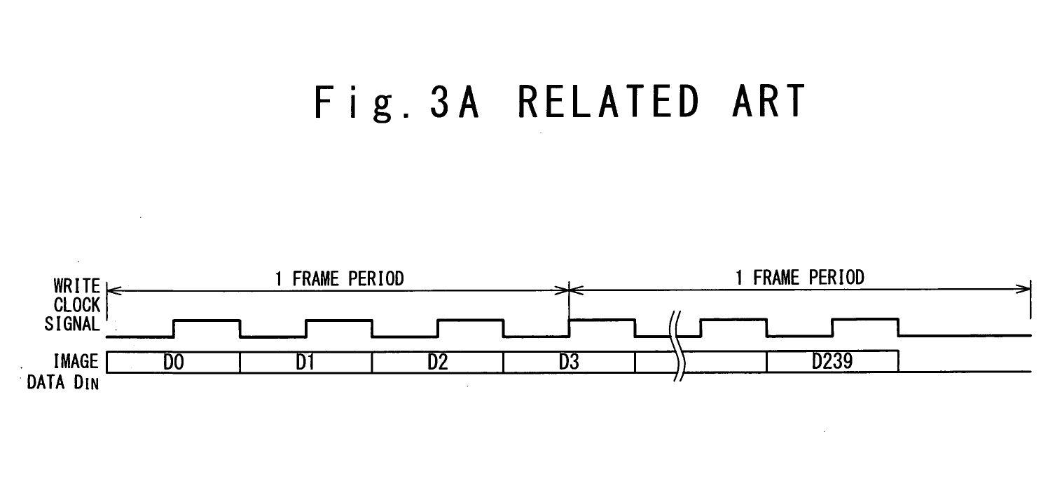

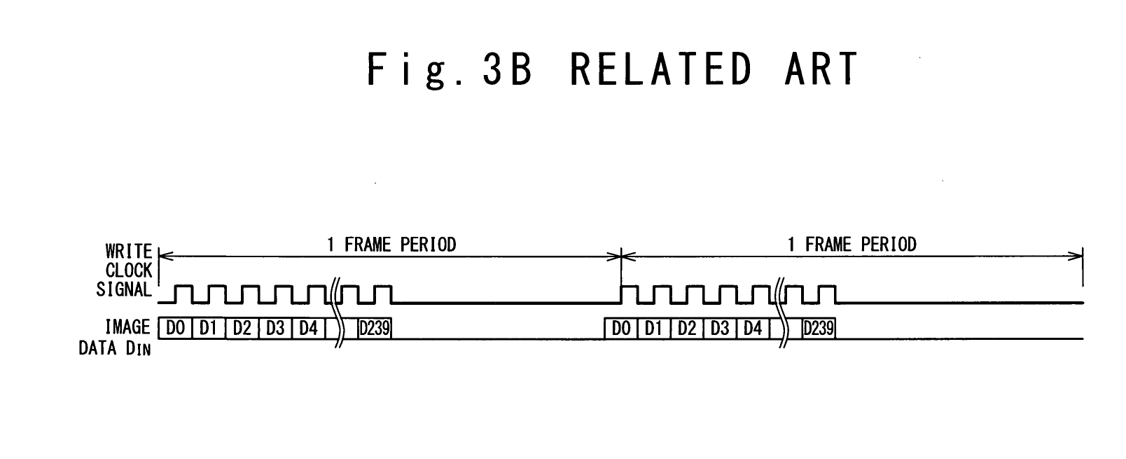

Giving detailed description, since the display memory 12 is built in the LCD driver 3 in the LCD display apparatus in the present embodiment, it is possible to independently control transfer of the pixel data D_{IN} from the image drawing unit 6 to the LCD driver 3 and drive of the data lines corresponding to the pixel data D_{IN} by the LCD driver 3. For this reason, it is possible to make variable a transfer rate of the pixel data D_{IN} from the image drawing unit 6 to the LCD driver 3 (namely, a write rate of the pixel data D_{IN} in the display memory 12). For example, it is possible to transfer the image data D_{IN} for one frame over a plurality of frame periods, as shown in FIG. 3A, and it also is possible to transfer the image data D_{IN} for one frame in a period shorter than one frame period, as shown in FIG. 3B. In addition, an operation of selectively transferring only the pixel data D_{IN} of pixels receiving a change among the pixels of the pixel array 4 to the LCD driver 3 also is possible.

In addition to this, the pixel data D_{IN} is compressed by the overdrive processing circuit 14 so as to generate the compressed image data which is written in the overdrive memory 13. Accordingly, an increase of the capacity of memories built into the LCD driver 3 can be controlled to a minimum. The LCD driver 3 stores the pixel data of two frames in total. However, a sum of capacities of the display memory 12 and the overdrive memory 13 may be smaller than a capacity necessary to hold the image data (not compressed) D_{IN} for two frames.

In generation of the compressed image data, it is important for the overdrive processing circuit 14 to perform a compressing process of (not the pixel data D_{IN} sent from the image drawing unit 6) the pixel data D_{IN} read out from the display memory 12, in order to independently control the transfer of the pixel data D_{IN} from the image drawing unit 6 to the LCD driver 3 and the drive of the data lines corresponding to the pixel data D_{IN} by the LCD driver 3. As described above, in case that the transfer of the pixel data D_{IN} from the image drawing unit 6 to the LCD driver 3 is asynchronous with the drive of the data lines corresponding to the pixel data D_{IN}, the pixel data D_{IN} transferred from the image drawing unit 6 to the LCD driver 3 is not necessarily coincident with the pixel data D_{IN} used to drive the data line in the current frame period. Therefore, if the compressed image data obtained by performing the compressing process on the pixel data D_{IN} sent from the image drawing unit 6 is stored in the overdrive memory 13, the compressed image data that is stored in the overdrive memory 13 will not be necessarily coincident with the pixel data D_{IN} that was actually used for the drive of the data line in the previous frame period. This can be a cause by which improper overdriving process is performed. By performing the compressing process of the pixel data D_{IN} read from the display memory 12 as in the present embodiment, it is possible to store the compressed image data corresponding to the pixel data D_{IN} actually used for the drive of the data lines in the previous frame period in the overdrive memory 13.

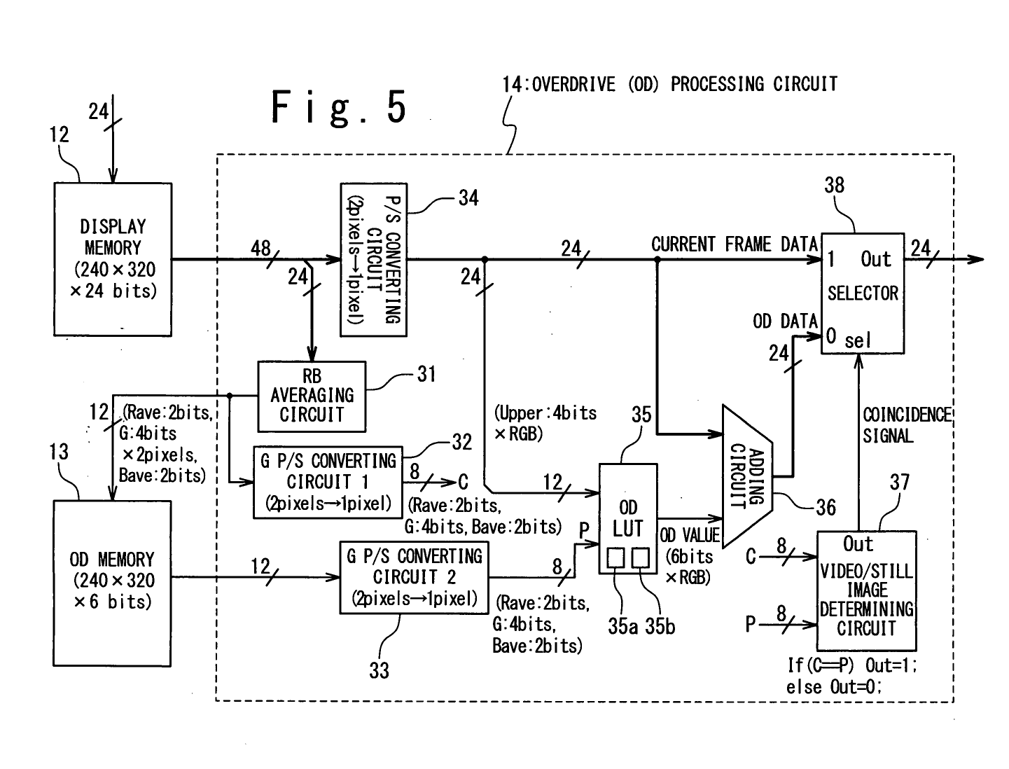

Next, a configuration and an operation of the overdrive processing circuit 14 for generating the compressed image data will be described in detail. FIG. 5 is a block diagram showing the configuration of the overdrive processing circuit 14. The overdrive processing circuit 14 includes an RB averaging circuit 31, G parallel-serial (P/S) converting circuits 32 and 33, a parallel-serial (P/S) converting circuit 34, an overdrive LUT circuit 35, an adding circuit 36, a video/still image determining circuit 37, and a selector 38. It should be noted that in the following description of the overdrive processing circuit 14, the operation of each circuit will be described, assuming that the number of pixels of the pixel array 4 is 240×320 (namely, H=240, V=320), the pixel data D_{IN} stored in the display memory 12 is 24-bit data (namely, k=24), and the compressed image data stored in the overdrive memory 13 is data that expresses the gradations of two pixels with 12 bits (namely, z=six).

The RB averaging circuit 31 compresses the pixel data D_{IN} currently stored in the display memory 12 to generate the compressed pixel data, and stores it in the overdrive memory 13. As described above, in the present embodiment, each of the compressed pixel data is 2×z bit data, and is generated from the pixel data D_{IN} of two pixels horizontally arranged. The averaging circuit 31 receives the pixel data D_{IN} Of two pixels in parallel, and outputs the compressed pixel data corresponding to the two pixels in parallel. A generating process of the compressed pixel data differs among data of the R display dot and data of the B display dot (R data and B data) and data of the G display dot (G data). A format of the compressed pixel data and its generating process will be described in detail.

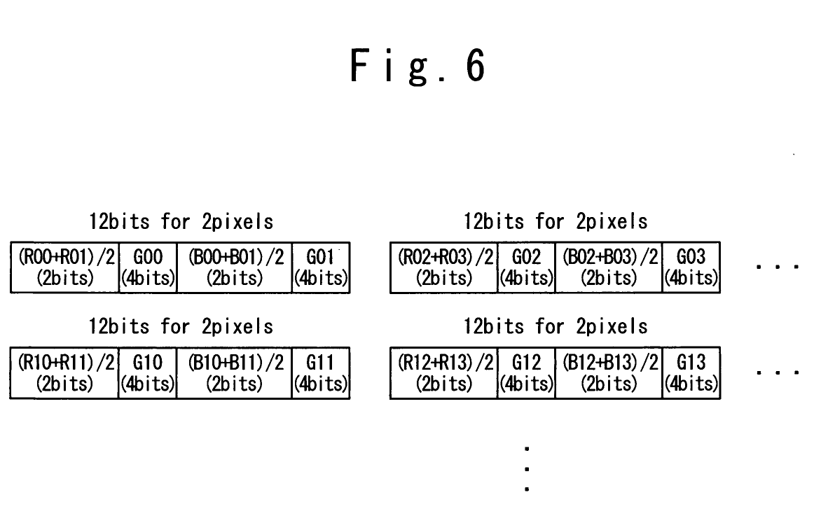

FIG. 6 is a diagram showing a format of the compressed pixel data generated by the averaging circuit 31. The each compressed pixel data includes four data: R average data 51, first G compressed data 52, B average data 53, and second G compressed data 54. The R average data 51 is a data corresponding to the R display dot of two pixels, and is calculated as upper bits of an average of the R data of the two pixels. The first G compressed data 52 is a data corresponding to the G display dot as one pixel of the two pixels. In the present embodiment, upper bits of the G data that is the G display dot of the one pixel are used as the first G compressed data 52. The B average data 53 is a data corresponding to the B display dot of two pixels, and is calculated as upper bits of an average of the B data of the two pixels. The second G compressed data 54 is a data corresponding to the G display dot of the other pixel of the two pixels. In the present embodiment, the upper bits of the G data that is the G display dot of the other pixel are used as the second G compressed data 54. In an example of FIG. 6, each of the R average data 51 and the B average data 53 is two bits, and each of the first G compressed data 52 and the second G compressed data 54 is four bits. Therefore, each compressed pixel data is 12-bit data (namely, z=6).

By writing the compressed pixel data generated in this way in the overdrive memory 13, a capacity of the overdrive memory 13 can be controlled. In case that the pixel data D_{IN} stored in the display memory 12 is 24-bit data (namely, in case of k=24) and the compressed pixel data is 12-bit data (per two pixels) (namely, in case of z=6), the capacity of the overdrive memory 13 may be one fourth of the capacity of the display memory 12. That is, although the LCD driver 3 in the present embodiment stores data of the gradations of the pixels of two frames, it needs only the memory with a capacity for storing the pixel data D_{IN} for 1.25 frames.

A G parallel-serial converting circuit 32 performs a parallel-serial conversion of the first G compressed data 52 and the second G compressed data 54 of the compressed pixel data outputted from the RB averaging circuit 31. Specifically, when having received the compressed pixel data including the R average data 51, the first G compressed data 52, the B average data 53, and the second G compressed data 54, the parallel-serial converting circuit 32 outputs the R average data 51, the first G compressed data 52, and the B average data 53 in a first clock cycle, and outputs the R average data 51, the second G compressed data 54, and the B average data 53 in a second clock cycle. It should be noted that in FIG. 5, the R average data 51 is referred to as the symbol “Rave,” the first G compressed data 52 and the second G compressed data 54 is referred to as the symbol “G,” and the B average data 53 is referred to as the symbol “Bave.” In addition, it should be noted that the R average data 51 and the B average data 53 are outputted twice for each compressed pixel data. The data outputted from the parallel-serial converting circuit 32 is a compressed data corresponding to the gradation of each pixel of the current frame, and is hereinafter referred to as a current frame compressed data C.

A G parallel-serial converting circuit 33 receives the compressed pixel data from the overdrive memory 13, and performs the parallel-serial conversion of the first G compressed data 52 and the second G compressed data 54 of the compressed pixel data from the overdrive memory 13. Specifically, when having received the compressed pixel data including the R average data 51, the first G compressed data 52, the B average data 53, and the second compressed data 54, the parallel-serial converting circuit 33 outputs the R average data 51, the first G compressed data 52, and the B average data 53 in the first clock cycle, and outputs the R average data 51, the second G compressed data 54, and the B average data 53 in the second clock cycle. Hereinafter, a same operation is repeated. The data outputted from the parallel-serial converting circuit 33 is a compressed data corresponding to the gradation of each pixel of the previous frame, and is hereinafter referred to as a previous frame compressed data P.

The parallel-serial converting circuit 34 receives the image data D_{IN} of two pixels arranged in parallel in the horizontal direction, and outputs the image data D_{IN} one pixel by one pixel. When the image data D_{IN} is k-bit data, a data width of an input of the parallel-serial converting circuit 34 is a 2×k bits, and a data width of an output is k bits. The data outputted from the parallel-serial converting circuit 34 is a pixel data corresponding to the gradation of each pixel of the current frame, and may be hereinafter referred to as a current frame data.

The overdrive (OD) LUT circuit 35 determines an overdrive value by a table lookup process using the current frame data received from the parallel-serial converting circuit 34 and the previous frame compressed data P received from the parallel-serial converting circuit 33. Here, the overdrive value is a value that is to be added to the gradation of an original display dot in order to improve responsiveness of a liquid crystal, and that is calculated for each of the R display dot, the G display dot, and the B display dot. In the present embodiment, the overdrive value is 6-bit data.

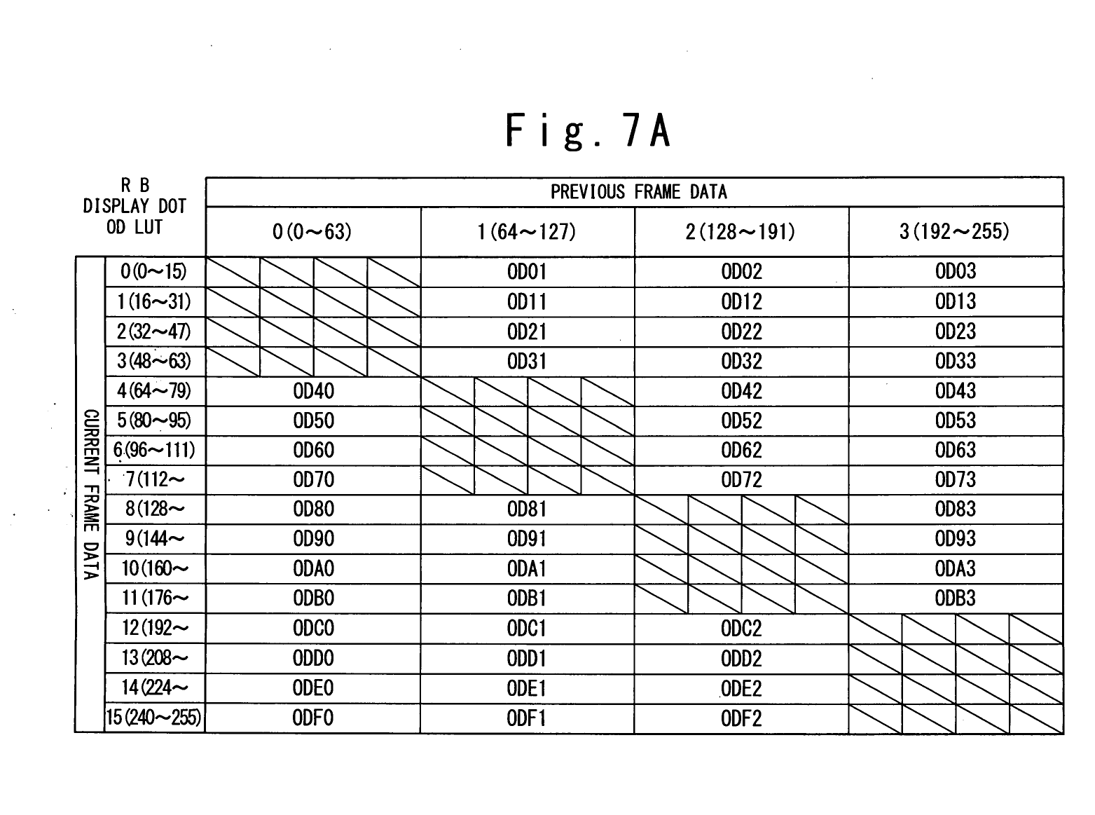

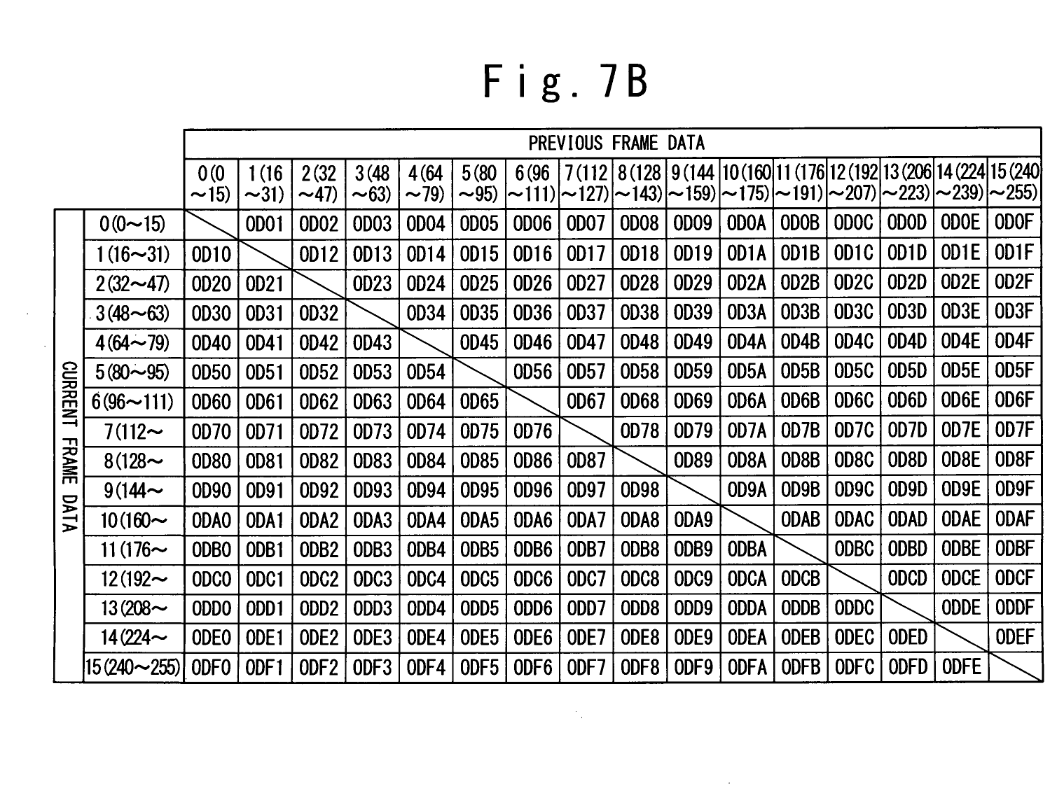

Describing in detail, the LUT circuit 35 stores a lookup table 35a for R and B and a lookup table 35b for G. As shown in FIG. 7A, the lookup table 35a for R and B is a lookup table used to determine the overdrive values of the R display dot and the B display dot, and defines a correspondence among the upper bits (in the present embodiment, top four bits) of the R data or B data of the current frame data, the R average data 51 or the B average data 53 of the previous frame compressed data, and the overdrive value. In FIG. 7A, each of slash lines indicates that the overdrive value is zero. Top four bits of the R data or B data of the current frame data are used to determine the overdrive values. In case that the overdrive value is 6-bit data and further each of the R average data 51 and the B average data 53 is of two bits, the size of the lookup table 35a for R and B is 16×4×6 bits. The LUT circuit 35 determines the overdrive value of the R display dot from upper bits of the R data of the current frame data and the R average data 51 of the previous frame compressed data using the lookup table 35a, and determines the overdrive value of the B display dot from the upper bits of the B data of the current frame data and the B average data 53 of the previous frame compressed data using the lookup table 35a.

On the other hand, as shown in FIG. 7B, the lookup table 35b for G is a lookup table used to determine the overdrive value of the G display dot, which defines a correspondence among the upper bits of the G data of the current frame data (in the present embodiment, top four bits), the G data of the previous frame compressed data (namely, the first G compressed data 52 or second G compressed data 54), and the overdrive value. In FIG. 7B, each of slash lines indicates that the overdrive value is zero. In case that top four bits of the G data of the current frame data are used to determine the overdrive value, the overdrive value is 6-bit data, and further each of the first G compressed data 52 and the second G compressed data is of four bits, the size of the lookup table 35b for G is 16×16×6 bits. The LUT circuit 35 determines the overdrive value of the G display dot from the upper bits of the G data of the current frame data and the G data of the previous frame compressed data (namely, the first G compressed data 52 or second G compressed data 54) using the lookup table 35b.

The adding circuit 36 adds the overdrive values of the R display dot, the G display dot, and the B display dot calculated by the LUT circuit 35 to the R data, the G data, and the B data of the current frame data received from the parallel-serial converting circuit 34, respectively, and thereby generates an overdrive image data.

The video/still image determining circuit 37 determines whether the gradations of an object pixel are identical between the previous frame and the current frame, and outputs the coincidence signal indicating the determination result. When the current frame compressed data C received from the serial-parallel converting circuit 32 and the previous frame compressed data P are coincident with each other, the video/still image determining circuit 37 sets the coincidence signal to “1,” and when it is not so, sets the coincidence signal to “0.”

Here, what is important is that the current frame compressed data C and the previous frame compressed data P are both subjected to the same process on the object pixel. The current frame compressed data C is the image data obtained by processing the current frame image data read out from the display memory by the averaging circuit 31 and the parallel-serial converting circuit 32. In contrast to this, the previous frame compressed data P is the image data obtained as follows. That is, the image data read out from the display memory has been processed by the averaging circuit 31, and has been stored in the overdrive memory 13. Subsequently, the data has been read from the overdrive memory 13 as the previous frame image data, and has been processed by the parallel-serial converting circuit 33. That is, the current frame compressed data C is the image data of the current frame whose object pixels are processed by the averaging circuit 31 and the parallel-serial converting circuit, whereas the previous frame compressed data P is the image data of the previous frame processed similarly. Therefore, when it is a still image, the current frame compressed data C and the previous frame compressed data P will b coincident with each other.

The selector 38 outputs either the current frame data or the overdrive image data in response to the coincidence signal from the video/still image determining circuit 37. Specifically, when the coincidence signal is the data “1,” the selector 38 outputs the current frame data, and when the coincidence signal is the data “0,” it outputs the overdrive image data. An output of the selector 38 is supplied to the shift register 15 as post-process image data. The post-process image data thus generated is coincident with the current frame data when the current frame compressed data C and the previous frame compressed data P are coincident with each other, and is coincident with the overdrive image data when they differ from each other.

One advantage of the overdrive processing circuit 14 in the present embodiment is in that both of an access between the overdrive processing circuit 14 and the display memory 12 and an access between the overdrive processing circuit 14 and the overdrive memory 13 are performed for each data of a plurality of pixels. Specifically, the overdrive processing circuit 14 in the present embodiment is configured to receive the image data D_{IN} of two pixels in parallel from the display memory 12. In addition, the overdrive processing circuit 14 in the present embodiment is configured to write the compressed image data corresponding to the two pixels in the overdrive processing circuit 14 and to read it therefrom. According to such a configuration, the number of times of the access between the overdrive processing circuit 14 and the display memory 12 and the number of times of the access between the overdrive processing circuit 14 and the overdrive memory 13 can be decreased, and consumed power of the display memory 12 and the overdrive memory 13 can be reduced.

Another advantage of the overdrive processing circuit 14 in the present embodiment is in that compression ratios C_{R} and C_{B} of the R data and the B data in the generation of the compressed pixel data are higher than a compression ratio C_{G} of the G data. Specifically, in the present embodiment, the compression ratios C_{R}, C_{G}, and C_{B} of the R data, the G data, and the B data satisfy following formulae.

C_{R}<C_{G} (1a)

C_{B}<C_{G} (1b),

where the compression ratios C_{R}, C_{G}, and C_{B} are

C_{R}=n_{R}/{2×(k/3)} (2a)

C_{G}=(2×n_{G})/{2×(k/3)} (2b)

C_{B}=n_{B}/{2×(k/3)} (2c).

In the equations (2a) to (2c), n_{R} is the number of bits of the R average data 51 of the compressed pixel data, n_{G} is the number of bits of each of the first G compressed data 52 and the second G compressed data 54, and n_{B} is the number of bits of the B average data 53. As in an example of FIG. 5, in case that k is 24 bits, both of n_{R} and n_{B} are two bits, and n_{G} is four bits, the following relations are satisfied:

C_{R}=C_{B}=12.5%

C_{G}=50%.

It should be noted that “compression ratio being high” means C_{R}, C_{G}, and C_{B} defined by the equations (2a) to (2c) have small values.

By using a fact that human visibilities to red and blue are lower than a human visibility to green, such a process makes it possible to reduce an amount of hardware resources necessary for the overdrive process, while controlling deterioration of image quality of an image displayed on the pixel array 4. In the overdrive process, as an amount of data on the gradations of the R display dot, the G display dot, and the B display dot increases (namely, when the numbers of bits of the R data, the G data, and the B data become more), the overdrive value can be determined more precisely and the image quality of the display image can be improved. However, even if the data on the gradations of the R display dot and the B display dot contained in the compressed pixel data are lessened since human visibilities to red and blue are comparatively low, deterioration in the image quality of the display image is small. Lessening the data on the gradations of the R display dot and the B display dot reduces a capacity of the overdrive memory 13 rather, and is effective to reduce hardware resources. On the other hand, if the data on the gradation of the G display dot is lessened since the human visibility to green is relatively high, deterioration in the image quality of a display image will become large. In the present embodiment, the compressed pixel data is generated based on such finding, so that the compression ratios of the R data and the B data may become higher than that of the G data. According to such a generation technique of the compressed pixel data, the amount of hardware resources necessary for the overdrive process can be reduced, while controlling deterioration of the image quality of the image displayed on the pixel array 4.

As described above, the liquid crystal display 1 in the present embodiment can control the increase of the capacity of the memory built in the LCD driver 3 to a minimum, while making the transfer rate of the pixel data D_{IN} from the image drawing unit 6 to the LCD driver 3 (namely, the write rate of the pixel data D_{IN} to the display memory 12) variable.

In addition, the liquid crystal display 1 in the present embodiment can decrease the number of times of access between the overdrive processing circuit 14 and the display memory 12, and the number of times of the access between the overdrive processing circuit 14 and the overdrive memory 13. Reduction of the number of times of the access is preferable in order to reduce the consumed power of the display memory 12 and the overdrive memory 13.

Further, the liquid crystal display 1 in the present embodiment can reduce the amount of hardware resources necessary for the overdrive process while maintaining the image quality of the image displayed on the pixel array 4, by setting the compression ratios of the R data and the B data in the compressed pixel data higher than the compression ratio of the G data.

It should be noted that in the present embodiment, although the R average data 51 is calculated as the upper bits of the average of the R data of two pixels, the R data of three or more pixels may be used for generation of the R average data 51. Similarly, the B data of three or more pixels may be used for generation of the B average data 53. Generally, if the R data and the B data of n pixels are used for calculation of the R average data and the B average data, the compressed pixel data includes the R average data, the B average data, and the first to nth G compressed data that is obtained by extracting higher bits of each G data of the n pixels.

### Second Embodiment

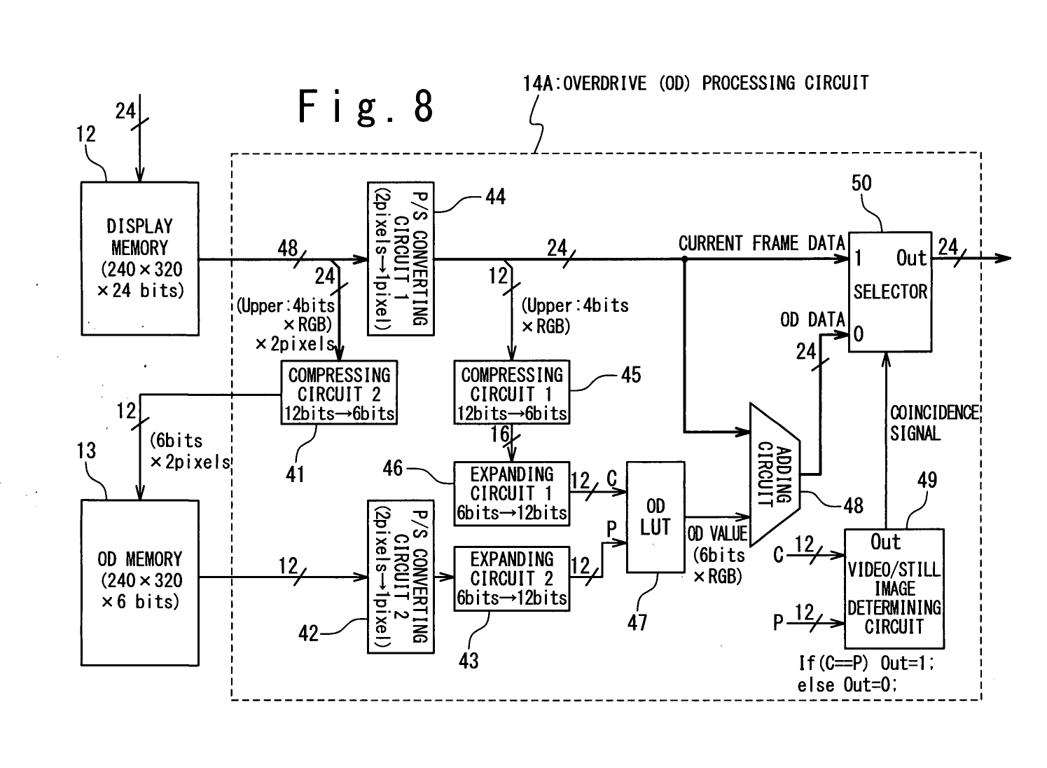

In the LCD display apparatus with LCD driver according to a second embodiment of the present invention, an overdrive processing circuit with a configuration different from the first embodiment is used. FIG. 8 is a block diagram showing the configuration of an overdrive processing circuit 14A in the second embodiment of the present invention. The overdrive processing circuit 14A includes a compressing circuit 41, a parallel-serial (P/S) converting circuit 42, a expanding circuit 43, a parallel-serial converting circuit 44, a compressing circuit 45, an expanding circuit 46, an OD LUT circuit 47, an adding circuit 48, a video/still image determining circuit 49, and a selector 50.

The image data D_{IN} is supplied to the overdrive processing circuit 14A from the display memory 12 for every two pixels. The compressing circuit 41 receives the upper bits (in the present embodiment, four higher bits) of the R data, the G data, and the B data of the image data D_{IN} of each pixel, and performs the compressing process of the upper bits of the R data, the G data, and the B data, respectively, to generate the compressed image data. In the present embodiment, the compressed image data is data that expresses the gradations of the R display dot, the G display dot, and the B display dot of one pixel with z bits in total, and z is equal to six in an example of FIG. 8. The compressing circuit 41 writes the generated compressed image data in the overdrive memory 13 in parallel for every two pixels. In the example of FIG. 8, 12 bits of the compressed image data of two pixels are written in the overdrive memory 13 in parallel.

The parallel-serial converting circuit 42 reads out the compressed image data of two pixels from the overdrive memory 13 in parallel, performs the parallel-serial conversion, and outputs the compressed image data for every one pixel.

The expanding circuit 43 expands the compressed image data outputted from the parallel-serial converting circuit 42. The data outputted from the expanding circuit 43 is data expressing the gradation of each display dot of each pixel of the previous frame, and is hereinafter called previous frame expanded data P. In the present embodiment, the previous frame expanded data P is data that express the gradations of the R display dot, the G display dot, and the B display dot with four bits (12 bits in total).

On the other hand, the parallel-serial converting circuit 44 receives the image data D_{IN} of two pixels aligned in the horizontal direction in parallel, and outputs the received image data D_{IN} one pixel by one pixel. When the image data D_{IN} is k-bit data, a data width of the input of the parallel-serial converting circuit 44 is 2×k bits, and a data width of the output is k bits. The data outputted from the parallel-serial converting circuit 44 is the current frame data, namely the pixel data corresponding to the gradations of each pixel of the current frame.

The compressing circuit 45 and the expanding circuit 46 are circuits used to generate current frame expanded data C in the same format as that of the previous frame expanded data P outputted from the expanding circuit 43. The compressing circuit 45 receives the upper bits of the R data, the G data, and the B data (in the present embodiment, the top four bits) of the current frame data outputted from the parallel-serial converting circuit 44, and performs the compressing process to the upper bits of the R data, the G data, and the B data to generate the compressed image data. The compressing circuit 45 and the compressing circuit 41 perform the compressing process with the same algorithm. A different point is in that the compressing circuit 45 processes the upper bits of the image data D_{IN} of two pixels in parallel, whereas the compressing circuit 45 processes the upper bits of the current frame data of one pixel. In the present embodiment, the compressed image data generated by the compressing circuit 45 is data that expresses gradations of the R display dot, the G display dot, and the B display dot of one pixel with z bits in total.

The expanding circuit 46 expands the compressed image data outputted from the compressing circuit 45 to generate the current frame expanded data C. The current frame expanded data C outputted from the expanding circuit 43 is data expressing gradations of display dots of each pixel of the current frame. In the present embodiment, the current frame expanded data C is data expressing gradations of the R display dot, the G display dot, and the B display dot of one pixel each with four bits (12 bits in total).

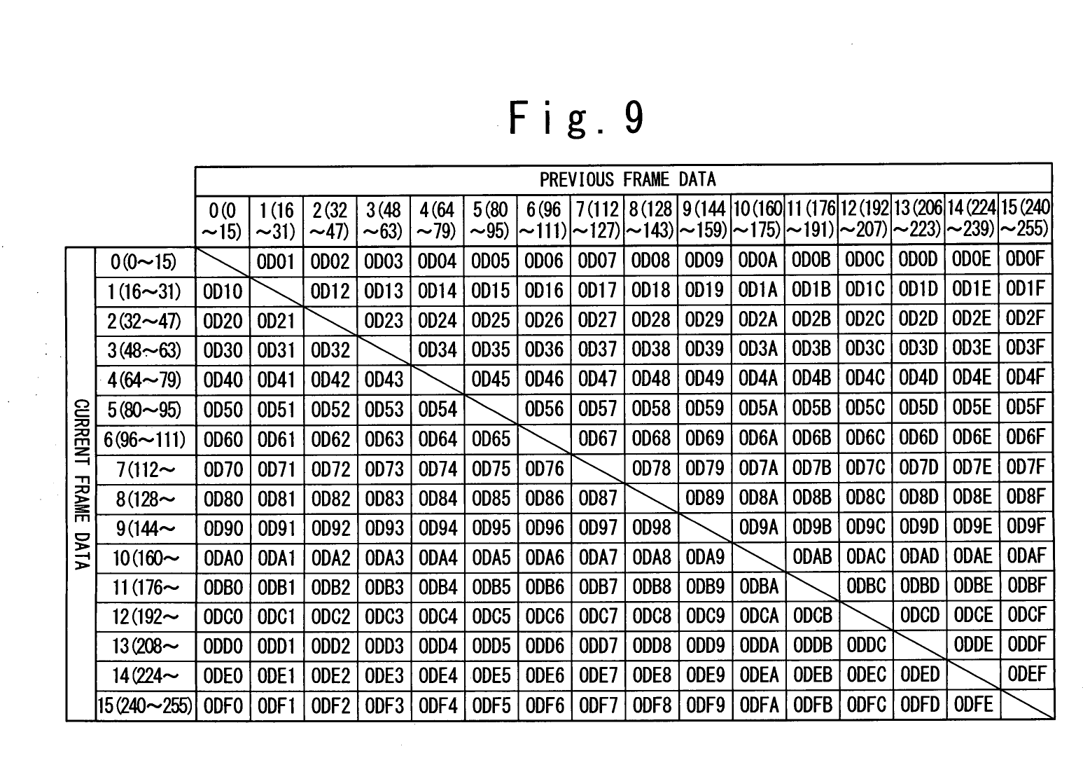

The LUT circuit 47 determines the overdrive value by table look-up based on the previous frame expanded data P received from the expanding circuit 43 and the current frame expanded data C received from the expanding circuit 46. The overdrive value is calculated for each of the R display dot, the G display dot, and the B display dot, and the overdrive value is 6-bit data in the present embodiment. FIG. 9 shows contents of the lookup table provided in the LUT circuit 47. In FIG. 9, each of slash lines indicates that the overdrive value is zero. In the present embodiment, the lookup table is used commonly to determine the overdrive values of the R display dot, the G display dot, and the B display dot. The lookup table provided in the LUT circuit 47 describes a correspondence among the current frame expanded data C, the previous frame expanded data P, and the overdrive value. The LUT circuit 47 determines the overdrive values of the R display dot, the G display dot, and the B display dot from the current frame expanded data C and the previous frame expanded data P using the lookup table.

The adding circuit 48 adds the overdrive values of the R display dot, the G display dot, and the B display dot calculated by the LUT circuit 35 to the R data, the G data, and the B data of the current frame data received from the parallel-serial converting circuit 44, respectively, and thereby generates the overdrive image data.

The video/still image determining circuit 49 determines whether the gradations of an object pixel are coincident with each other (roughly) between the previous frame and the current frame and outputs a coincidence signal indicating a determination result. More specifically, when the previous frame expanded data P received from the expanding circuit 43 is coincident with the current frame expanded data C received from the expanding circuit 46, the video/still image determining circuit 49 sets the coincidence signal to the data “1,” and when it is not so, it sets the coincidence signal to the data “0.”

The selector 50 outputs either the current frame data or the overdrive image data in response to a coincidence signal from the video/still image determining circuit 49. Specifically, the selector 50 outputs the current frame data when the coincidence signal is the data “1,” and outputs the overdrive image data when the coincidence signal is the data “0.” An output of the selector 50 is supplied to the shift register 15 as the post-process image data. The post-process image data thus generated is coincident with the current frame data when the current frame expanded data C and the previous frame expanded data are coincident with each other, whereas it is coincident with the overdrive image data when the both differ from each other.

Also, in a configuration of the overdrive processing circuit 14A of the second embodiment, the transfer rate of the pixel data D_{IN} from the image drawing unit 6 to the LCD driver 3 (i.e., the write rate of the pixel data D_{IN} to the display memory 12) can be made variable, and at the same time the increase of the capacity of the memory built in the LCD driver 3 can be suppressed to a minimum.

Moreover, with a configuration of the overdrive processing circuit 14A of the second embodiment, like the first embodiment, the number of times of access between the overdrive processing circuit 14A and the display memory 12 and the number of times of access between the overdrive processing circuit 14A and the overdrive memory 13 can be decreased, and the consumed power of the display memory 12 and the overdrive memory 13 can be reduced.

It should be noted that, similarly with the first embodiment, in the overdrive processing circuit 14A of the second embodiment, the compressed pixel data can be generated so that the compression ratio C_{R}, C_{B} of the R data and the B data may become higher than the compression ratio C_{G} of the G data. As described above, an amount of hardware resources necessary for the overdrive process can be reduced while maintaining the image quality of the image displayed on the pixel array 4.

Although the present invention has been described above in connection with several embodiments thereof, it would be apparent to those skilled in the art that those embodiments are provided solely for illustrating the present invention, and should not be relied upon to construe the appended claims in a limiting sense.

What is claimed is:

1. A liquid crystal display apparatus comprising:
a liquid crystal display (LCD) panel; and
an LCD driver,
wherein said LCD driver comprises:
a first memory having a capacity more than a capacity of image data for one frame and configured to receive the image data externally to store therein;
a second memory;
an overdrive processing circuit configured to compress the image data read out from said first memory to generate a compressed image data, write the generated compressed image data in said second memory, and perform an overdrive process based on the image data of a current frame read out from said first memory and the compressed image data of a previous read out from said second memory to generate a post-process image data; and
a data line driving section configured to drive data lines of said LCD panel in response to the post-process image data.

2. The liquid crystal display apparatus according to claim 1, wherein said overdrive processing circuit reads the image data from said first memory for every two or more pixels.

3. The liquid crystal display apparatus according to claim 2, wherein said overdrive processing circuit comprises:
a parallel/serial converting circuit configured to perform a parallel/serial converting process on the current frame image data read out from said first memory to output the image data for every pixel; and
a post-process image data generating section configured to calculate the post-process image data based on the current frame image data outputted from said parallel/serial converting circuit and the previous frame compressed image data read out from said second memory.

4. The liquid crystal display apparatus according to claim 2, wherein said overdrive processing circuit performs a write operation and a read operation of the compressed image data to said second memory every two or more pixels.

5. The liquid crystal display apparatus according to claim 4, wherein each of the two or more pixels contains an R display dot for a red display, a G display dot for a green display and a B display dot for a blue display,
each image data contains an R data indicating a gradation of the R display dot, a G data indicating a gradation of the G display dot, and a B data indicating a gradation of the B display dot, and
each of the compressed image data contains an R average data calculated by extracting upper bits from an average of the R data of the two or more pixels, a G average data calculated by extracting upper bits from an average of the G data of the two or more pixels, and a B average data calculated by extracting upper bits from an average of the B data of the two or more pixels.

6. The liquid crystal display apparatus according to claim 1, wherein said LCD panel has a plurality of pixels, each of which contains an R display dot for a red display, a G display dot for a green display and a B display dot for a blue display,
each image data contains an R data indicating a gradation of the R display dot, a G data indicating a gradation of the G display dot, and a B data indicating a gradation of the B display dot, and
in the generation of the compressed image data, compression ratios of the R data and the B data are higher than a compression ratio of the G data.

7. The liquid crystal display apparatus according to claim 1, wherein said overdrive processing circuit comprises:
a compression processing circuit configured to compress the current frame image data read out from said first memory to generate the compressed image data;
an overdrive image data generating circuit configured to perform the overdrive process on the current frame image data read out from said first memory based on the previous frame compressed image data read our from said second memory to generate an overdrive image data;
a video/still image determining circuit configured to compare the current frame compressed image data received from said compressed processing circuit and the precious frame compressed image data read from said second memory; and
a selector configured to select as the post-process image data, one of the current frame image data read from said first memory and the overdrive image data in response to an output from said video/still image determining circuit.

8. A liquid crystal display (LCD) driver comprising:
a first memory configured to receive the image data externally to store therein;
a second memory;
an overdrive processing circuit configured to compress the image data read out from said first memory to generate a compressed image data, write the generated compressed image data in said second memory, and perform an overdrive process based on the image data of a current frame read out from said first memory and the compressed image data of a previous read out from said second memory to generate a post-process image data; and
a data line driving section configured to drive data lines of an LCD panel in response to the post-process image data.

9. The LCD driver according to claim 8, wherein said overdrive processing circuit reads the image data from said first memory for every two or more pixels.

10. The LCD driver according to claim 9, wherein said overdrive processing circuit comprises:
a parallel/serial converting circuit configured to perform a parallel/serial converting process on the current frame image data read out from said first memory to output the image data for every pixel; and
a post-process image data generating section configured to calculate the post-process image data based on the current frame image data outputted from said parallel/serial converting circuit and the previous frame compressed image data read out from said second memory.

11. The LCD driver according to claim 9, wherein said overdrive processing circuit performs a write operation and a read operation of the compressed image data to said second memory every two or more pixels.

12. The LCD driver according to claim 11, wherein each of the two or more pixels contains an R display dot for a red display, a G display dot for a green display and a B display dot for a blue display,
each image data contains an R data indicating a gradation of the R display dot, a G data indicating a gradation of the G display dot, and a B data indicating a gradation of the B display dot, and
each of the compressed image data contains an R average data calculated by extracting upper bits from an average of the R data of the two or more pixels, a G average data calculated by extracting upper bits from an average of the G data of the two or more pixels, and a B average data calculated by extracting upper bits from an average of the B data of the two or more pixels.

13. The LCD driver according to claim 8, wherein said LCD panel has a plurality of pixels, each of which contains an R display dot for a red display, a G display dot for a green display and a B display dot for a blue display,
each image data contains an R data indicating a gradation of the R display dot, a G data indicating a gradation of the G display dot, and a B data indicating a gradation of the B display dot, and
in the generation of the compressed image data, compression ratios of the R data and the B data are higher than a compression ratio of the G data.

14. The LCD driver according to claim 8, wherein said overdrive processing circuit comprises:
a compression processing circuit configured to compress the current frame image data read out from said first memory to generate the compressed image data;
an overdrive image data generating circuit configured to perform the overdrive process on the current frame image data read out from said first memory based on the previous frame compressed image data read our from said second memory to generate an overdrive image data;
a video/still image determining circuit configured to compare the current frame compressed image data received from said compressed processing circuit and the precious frame compressed image data read from said second memory; and
a selector configured to select as the post-process image data, one of the current frame image data read from said first memory and the overdrive image data in response to an output from said video/still image determining circuit.

15. An operation method of an LCD driver, comprising:
receiving an image data externally to store in a first memory of said LCD driver;
compressing said image data read from said first memory to generate a compressed image data;
writing the generated compressed image data in a second memory of said LCD driver;
performing an overdrive process based on the image data of a current frame read from said first memory and the compressed image data of a previous frame read from said second memory, to generate a post-process image data; and
driving data lines of a LCD panel in response to the post-process image data.
